(19) United States
(12) Patent Application Publication
(10) Pub. No.: US 2009/0146763 A1
(43) Pub. Date: Jun. 11, 2009

(54) High Q Surface Mount Technology Cavity Filter

(75) Inventor: Rafi Hershtig, Salisbury, MD (US)

Correspondence Address: BANNER & WITCOFF, LTD., 1100 13th STREET, N.W., SUITE 1200, WASHINGTON, DC, 20005-4051, US

(73) Assignee: K&L Microwave Inc., Salisbury, MD (US)

(21) Appl. No.: 12/329,098

(22) Filed: Dec. 5, 2008

Related U.S. Application Data
(60) Provisional application No. 61/012,203, filed on Dec. 7, 2007.

(51) Int. Cl. H01P 1/20

(52) U.S. Cl. 333/204

(57) ABSTRACT

A cavity filter device includes a micro-strip structure comprising a low dielectric organic material forming a printed wiring board. The printed wiring board may be soldered, welded, or adhered to the base of one or more cavity filters. The cavity filter may include a coupling pin such as a RF pin positioned at the base of the filter. The micro-strip structure may be configured to carry a RF signal from the input, across the micro-strip structure to the RF pin positioned at the base of the filter.

### FIELD OF THE INVENTION

The invention relates generally to apparatus and methods related to cavity filters and more particularly to leadless surface mount technology cavity filters.

### BACKGROUND OF THE INVENTION

Miniaturization of surface mount technology components in the area of cavity filters is difficult to accomplish with any degree of acceptable component Insertion-Loss. While high Q components offer increased range and/or reduced noise, these components are often too costly and too large for the given application. Further, while miniaturized components often meet the mechanical and cost specifications, conventionally, they could not be constructed with sufficiently high Q to increase range and reduce noise. It has been found that the use of a Lead-Less SMT air cavity filter solves the above mentioned problems.

### SUMMARY OF THE INVENTION

In a first embodiment of an aspect of the invention, a cavity filter device includes a micro-strip structure comprising a low dielectric organic material forming a printed wiring board. The printed wiring board may be soldered, welded, or adhered to the base of one or more cavity filters. The cavity filter may include a coupling pin such as a RF pin positioned at the base of the filter. The micro-strip structure may be configured to carry a RF signal from the input, across the micro-strip structure to the RF pin positioned at the base of the filter.

In a first method, the filter may be adapted for particular performance criteria using planar simulators, such as Sonnet. Applying a suitable configuration such as the foregoing, the transition is analyzed over a wide frequency range and its S-parameters are stored. In exemplary embodiments, the filter is designed to suite the RF specifications and optimized between the stored S-parameters at both of its ports. In this manner, the filter may be matched between two complex loads by changing the internal impedance and couplings between the resonators. In addition, the correct tap point to the first and last resonators may be obtained, for example, by modeling all the transition between the S-parameters and the filter.

Between the I/O ports, the printed wiring board may include and preferably is filled with plated-through-holes to ensure sufficient isolation. This configuration helps reduce the rejection, which is a typical problem of surface mount technology filters. The assembly of the filter and the associated printed wiring board adopter may employ SN-96 solder which may be configured with a melting range of 221 c-229 c. This further enable the complete unit to be solder reflowed into the end product with SN-63.

The above and other objects, features and advantages of the present invention will be readily apparent and fully understood from the following detailed description of preferred embodiments, taken in connection with the appended drawings.

### BRIEF DESCRIPTION OF THE DRAWINGS

FIG. 1 shows a pictorial view of the surface mount cavity filter;

FIG. 2 shows a cross sectional view of the cavity filter;

FIG. 3 shows a top planer view of the cavity filter;

FIG. 4 shows a bottom planar view of the printed wiring board of the surface mount cavity filter;

FIG. 5 shows an exemplary wide band response for the surface mount cavity filter; and

FIG. 6 shows a narrow band response of the surface mount cavity filter.

### DETAILED DESCRIPTION OF THE PREFERRED EMBODIMENTS

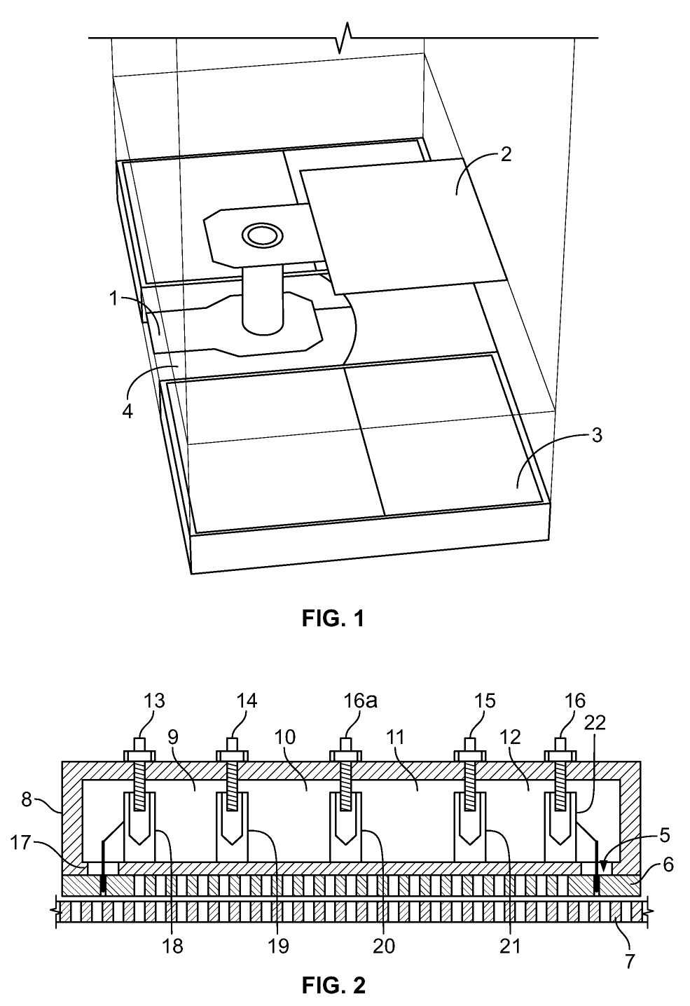

Referring to FIG. 1, a first exemplary embodiment of a leadless surface mount technology cavity filter is shown. In this embodiment, a graphic representation is shown of a surface mount technology transition from a R04003 (13 mils) to FV Cavity through R04003 (31 mils). In this manner, the signal flow of the RF from the printed wiring board to the cavity filter may be accomplished with very little loss. For example, a first connection 1 coupled to a RF pin with then may be coupled to the base of the cavity filter with very little loss.

FIG. 2 shows a cross sectional view of one embodiment of the leadless surface mount technology cavity filter. In this embodiment, a cavity filter 8 is disposed on a printed wiring board 7. Coupled between the printed wiring board 7 and the cavity filter 8 is a printed wiring adaptor 6. RF Pins 5, 17, may be coupled at opposite ends of the cavity filter. The cavity filter may be variously configured to include a plurality of cavities 9, 10, 11, 12, with or without various tuning screws such as 13, 14, 15, 16, 16a disposed in apertures 18, 19, 20, 21, 22 which are disposed between cavities.

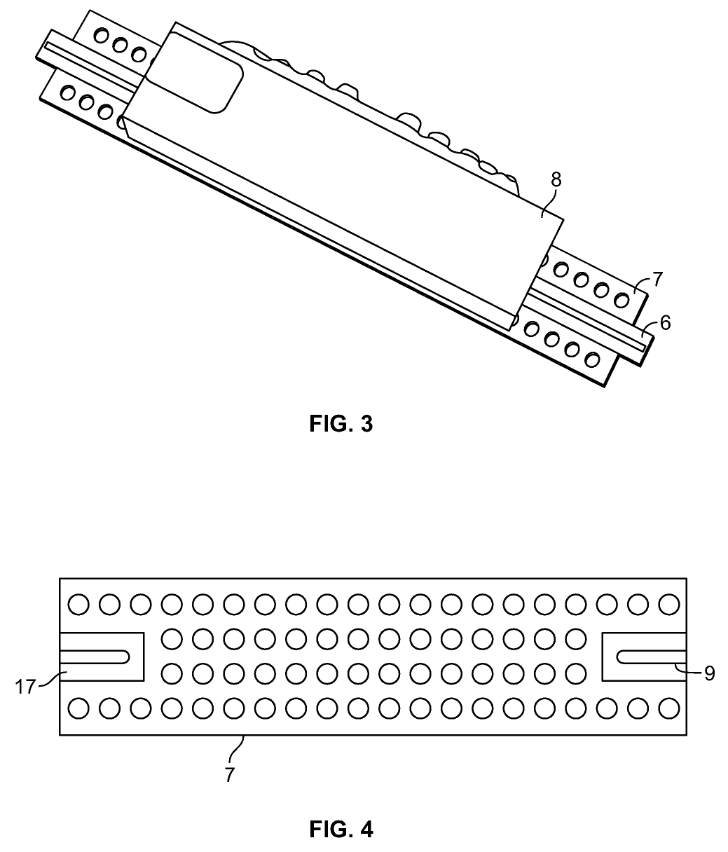

FIG. 3 shows an exemplar top planar view of the surface mount cavity filter 8 having tuning screws output from the top, the printed wiring board 7, and the RF pins 5, 17.

FIG. 4 shows the bottom side of the printed wiring board having the through vias. The printed wiring board may be a Rogers R04003 having a suitable thickness such as about 0.012″, with ½ ounce of copper on both sides of the board. The length may be about 0.5, 1, 1.5, 2.0, 2.5, or larger. The width may be 0.15, 0.20, 0.25, 0.30, 0.38, 0.45, 0.50, or 0.60 or larger.

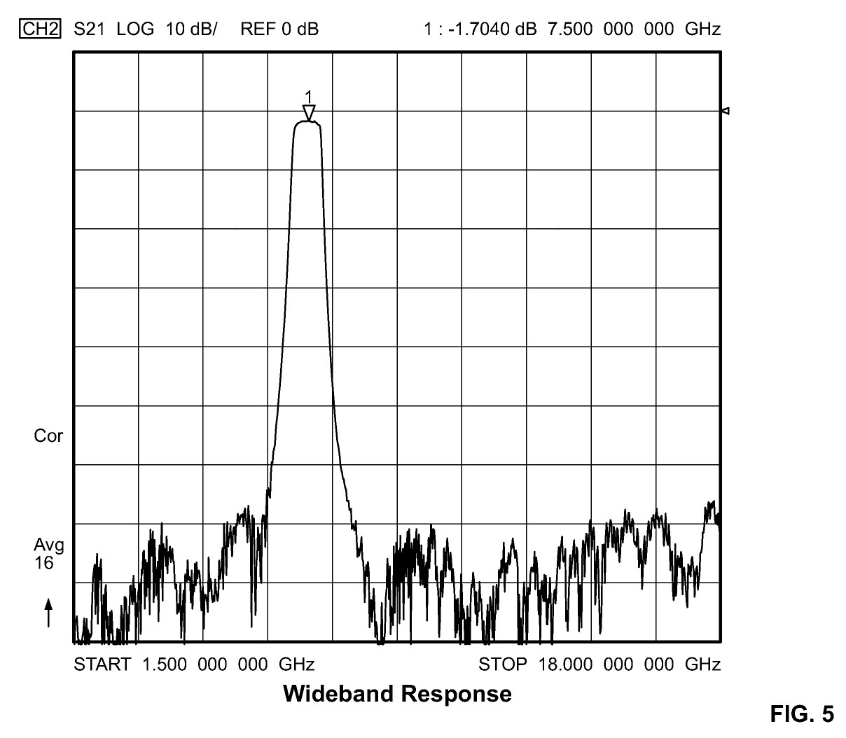

Referring to FIG. 5, a wide band response is shown. Note the very desirable response curve exhibited by the filter.

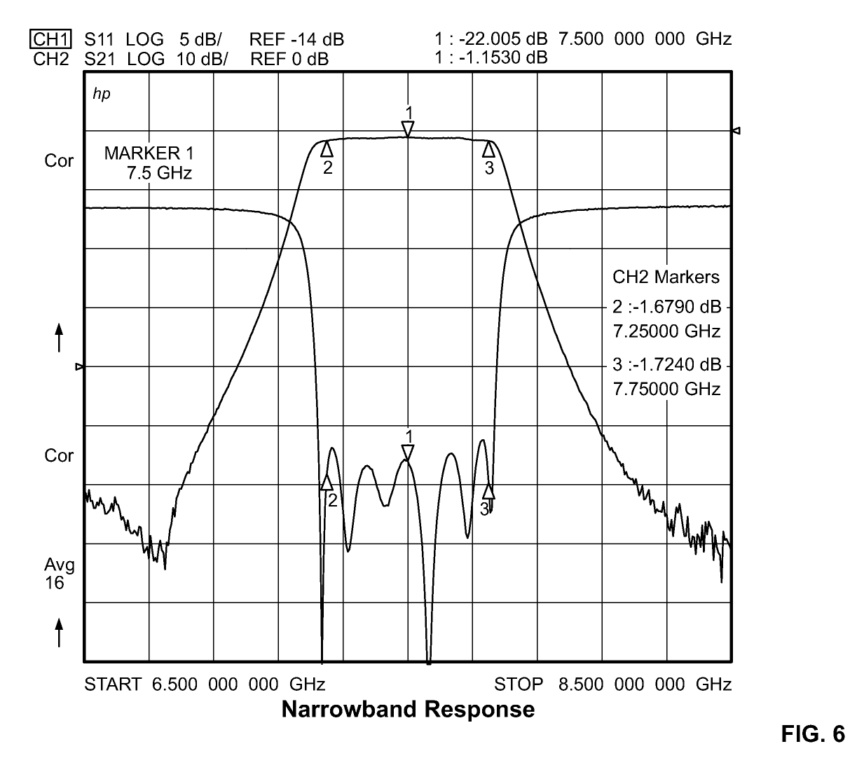

Referring to FIG. 6, the narrow band response is shown. Again, the filter results in a very favorable narrow band response.

The transition from the printed wiring board to the rf pins in encapsulated in a suitable material such as epoxy. This enables the cavity filter to have excellent matching characteristics and keeps the ultimate rejection levels down. The resulting cavity filter offers high Q, and a low-loss response that was heretofore not possible with surface mount technologies. The use of a leadless carrier saves connector space and yet still provides good transitions for all types of filters.

As shown in the above FIGS. 1-4, a cavity filter device includes a micro-strip structure comprising a low dielectric organic material forming a printed wiring board. The printed wiring board may be soldered, welded, or adhered to the base of one or more cavity filters. The cavity filter may include a coupling pin such as a RF pin positioned at the base of the filter. The micro-strip structure may be configured to carry a RF signal from the input, across the micro-strip structure to the RF pin positioned at the base of the filter.

In a first method employing the cavity filter shown in FIGS. 1-4 may include one or more of the following. First, the filter may be adapted for particular performance criteria using planar simulators, such as Sonnet. Applying a suitable configuration such as the foregoing, the transition is analyzed over a wide frequency range and its S-parameters are stored. In exemplary embodiments, the filter is designed to suite the RF specifications and optimized between the stored S-parameters at both of its ports. In this manner, the filter may be matched between two complex loads by changing the internal impedance and couplings between the resonators. In addition, the correct tap point to the first and last resonators may be obtained, for example, by modeling all the transition between the S-parameters and the filter.

In embodiments shown in FIGS. 1-4, between the I/O ports, the printed wiring board may include and preferably is filled with plated-through-holes to ensure sufficient isolation. This configuration helps reduce the rejection, which is a typical problem of surface mount technology filters. The assembly of the filter and the associated printed wiring board adopter may employ SN-96 solder which may be configured with a melting range of 221 c-229 c. This further enable the complete unit to be solder reflowed into the end product with SN-63.

1. An apparatus comprising:
a micro-strip structure comprising a low dielectric organic material forming a printed wiring board;
one or more cavity filters including a coupling pin extending from a base of the cavity filter; and
a micro-strip structure configured to transmit a RF signal from an input, across the micro-strip structure, to the RF pin.
